(19) United States
(12) Patent Application Publication
(10) Pub. No.: US 2015/0019386 A1
(43) Pub. Date: Jan. 15, 2015

(54) OPERATION DEVICE AND COMPUTER PROGRAM

(71) Applicant: Sharp Kabushiki Kaisha, Osaka (JP)

(72) Inventor: Yoichi Kimura, Osaka (JP)

(21) Appl. No.: 14/384,061

(22) PCT Filed: Mar. 11, 2013
(86) PCT No.: PCT/JP2013/056602

§ 371 Date: Sep. 9, 2014

(30) Foreign Application Priority Data
Mar. 13, 2012 (JP) 2012-056165

(51) Int. Cl. G06Q 10/08; G06Q 30/06

(52) U.S. Cl. CPC G06Q 10/087; G06Q 30/0635
USPC 705/26.81; 705/28

(57) ABSTRACT

An operation device determines, when it is determined that a consumable is gradually consumed, whether or not the remaining quantity of the consumable is not more than 50%. When it is determined that the remaining quantity is not more than 50%, and it is in a fixed value order mode, the operation device executes order processing for transmitting order information of ordering the consumable. Also, when it is determined that the remaining quantity is not more than 50%, that it is in a consumption prediction mode, and that the prediction period to the time when the remaining quantity becomes 0 is within 10 days, the operation device executes order processing.

### CROSS-REFERENCE TO RELATED APPLICATIONS

This application is the national phase under 35 U.S.C. §371 of PCT International Application No. PCT/JP2013/056602 which has an International filing date of Mar. 11, 2013 and designated the United States of America.

### FIELD

The present invention relates to an operation device which operates with gradually consuming a consumable which can be supplied or exchanged, and a computer program which is executed by the operation device.

### BACKGROUND

Japanese Patent Application Laid-open No. 2003 discloses, in a device which operates with gradually consuming a consumable which can be supplied or exchanged, such as tonner, a method for deciding the date for ordering a consumable based on the remaining quantity of the consumable and placing the order for the consumable on the decided date.

According to the device described in Japanese Patent Application Laid-open No. 2003-15477, an order can be placed at an appropriate timing by each user. Therefore, it is possible to avoid a situation that the device cannot be used because a consumable is not delivered and to shorten a period for storing unnecessary consumables.

Such a device that indicates a timing relating to an order placement, exchange or the like of a consumable is also disclosed in Japanese Patent Application Laid-open No. 2004-13750, Japanese Patent Application Laid-open No. 2003-89255, and Japanese Patent Application Laid-open No. 2011-197293.

Each of the devices disclosed in Japanese Patent Application Laid-open No. 2003-15477, Japanese Patent Application Laid-open No. 2004-13750, Japanese Patent Application Laid-open No. 2003-89255, and Japanese Patent Application Laid-open No. 2011-197293 detects the remaining quantity of a consumable and calculates the timing of, for example, a date for placing an order, based on the detected remaining quantity. The remaining quantity of the consumable is derived based on a detection result obtained by detecting items, namely, the weight of the consumable, an operation time of a motor that drives when the consumable is consumed, and the number of printing pages.

### SUMMARY

However, the remaining quantity of a consumable derived in such a manner has a margin of error and may be different from the actual remaining quantity of the consumable. For example, when the actual remaining quantity is less than the derived remaining quantity of the consumable, such a problem arises that a consumable is not delivered when exchanging or supplying the consumable is required so that the device cannot be used. Also, for example, when the actual remaining quantity is more than the derived remaining quantity, the timing of placing an order comes too early, which results in a longer storage period of the consumable and an increase in the storage amount.

The present invention is made in view of the above circumstances. An object of the present invention is to provide an operation device and a computer program which are able to properly adjust an ordering timing by, when it is determined that a consumable is consumed, performing an output relating to supply or exchange of the consumable based on a result obtained by comparing a predicted period to the time when the consumable is exchanged or a remaining quantity with a predetermined value.

An operation device according to the present invention is an operation device operating with gradually consuming a consumable which can be supplied or exchanged, comprising: a remaining quantity detection means for detecting a remaining quantity of the consumable; a determination means for determining whether or not the consumable is gradually consumed; a calculation means for calculating a period to the time when the consumable needs to be supplied or exchanged, based on a change with time of the detected remaining quantity, when it is determined that the consumable is gradually consumed; a determination means for determining whether or not a value indicating the period calculated by the calculation means is not more than a set value; and an output means for performing an output relating to supply or exchange of the consumable when it is determined that the value is not more than the set value by the determination means.

In the present invention, when it is determined that the consumable is used, it is possible to properly adjust a timing of output by predicting the period to the time when the consumable is supplied or exchanged in accordance with a change with time in the remaining quantity, and performing the output relating to supply or exchange of the consumable based on the predicted period.

An operation device according to the present invention is an operation device operating with gradually consuming a consumable which can be supplied or exchanged, comprising: a remaining quantity detection means for detecting a remaining quantity of the consumable; a determination means for determining whether or not the consumable is gradually consumed; a determination means for determining whether or not the detected remaining quantity is not more than a set value when it is determined that the consumable is gradually consumed; and an output means for performing an output relating to supply or exchange of the consumable when it is determined that the remaining quantity is not more than the set value by the determination means.

In the present invention, when it is determined that the consumable is used and the remaining quantity is not more than the set value, it is possible to properly adjust a timing of output by performing the output relating to supply or exchange of the consumable.

The operation device according to the present invention, further comprising a means for comparing the remaining quantity detected by the remaining quantity detection means with a set value, wherein the calculation means calculates the period when it is determined that the remaining quantity is not more than the set value.

In the present invention, when the remaining quantity is not more than the set value, it is possible to properly adjust a timing of output by performing an output relating to supply or exchange of the consumable.

The operation device according to the present invention, further comprising a means for determining a status of supply or exchange of the consumable after the output means performs the output, wherein the determination means determines whether or not the consumable is gradually consumed, when it is determined that the consumable has been supplied or exchanged.

In the present invention, after performing the output by the output means, it is possible to prevent double output by not performing determination on supply or exchange until the consumable is supplied or exchanged.

The operation device according to the present invention, wherein a plurality of consumables are to be consumed, and the determination means performs, based on a set value defined in accordance with a status of supply or exchange of one consumable, a determination relating to another consumable.

In the present invention, it is possible to adjust the set value such that outputs relating to the plurality of consumables are performed around the same time.

The operation device according to the present invention, wherein the output means externally transmits order information for ordering the consumable as an output relating to supply or exchange of the consumable.

In the present invention, it is possible to perform ordering the consumable automatically.

A computer program according to the present invention is a computer program causing a computer, which operates with gradually consuming a consumable which can be supplied or exchanged, to execute the procedures of: determining whether or not the consumable is gradually consumed; calculating a period to the time when the consumable needs to be supplied or exchanged, based on a change with time of a remaining quantity of the consumable, when it is determined that the consumable is gradually consumed; and

determining whether or not a value indicating the calculated period is not more than a set value; and performing an output relating to supply or exchange of the consumable when it is determined that the value is not more than the set value.

In the present invention, when it is determined that the consumable is used, it is possible to properly adjust a timing of output by predicting the period to the time when the consumable is supplied or exchanged in accordance with a change with time in the remaining quantity, and performing an output relating to supply or exchange of the consumable based on the predicted period.

A computer program according to the present invention is a computer program causing a computer, which is operated with gradually consuming a consumable which can be supplied or exchanged, to execute the procedures of: determining whether or not the consumable is gradually consumed; determining whether or not a remaining quantity of the consumable is not more than a set value when it is determined that the consumable is gradually consumed; and performing an output relating to supply or exchange of the consumable when if it is determined that the remaining quantity is not more than the set value.

In the present invention, when it is determined that the consumable is used and the remaining quantity is not more than the set value, it is possible to properly adjust a timing of output by performing an output relating to supply or exchange of the consumable.

The operation device and the computer program according to the present invention perform an output of, for example, an order of a consumable, to the outside, when it is determined that a consumable is used, and when a period to the time when the consumable is supplied or exchanged is within a predetermined period, or the remaining quantity is not more than a set value. Thereby, it is possible to provide an effect that the timing of outputting an order or the like can be adjusted and an occurrence of problem that the device cannot be used due to the delay in ordering the consumable can be prevented.

The above and further objects and features will more fully be apparent from the following detailed description with accompanying drawings.

### BRIEF DESCRIPTION OF THE DRAWINGS

FIG. 1 is a block diagram illustrating a configuration example of an ordering system using an operation device of the present invention;

FIG. 2A is a graph illustrating a premise of processing for properly adjusting an ordering timing according to the operation device of the present invention;

FIG. 2B is a graph illustrating a premise of processing for properly adjusting an ordering timing according to the operation device of the present invention;

FIG. 2C is a graph illustrating a premise of processing for properly adjusting an ordering timing according to the operation device of the present invention;

FIG. 3 is a flowchart illustrating an example of determination processing at the operation device of the present invention;

FIG. 4 a flowchart illustrating an example of the determination processing at the operation device of the present invention;

FIG. 5 is a flowchart illustrating an example of adjustment determination processing at the operation device of the present invention; and

FIG. 6 is a flowchart illustrating an example of adjustment determination processing at the operation device of the present invention.

### DETAILED DESCRIPTION

The present invention is described below with reference to the drawings illustrating an embodiment thereof.

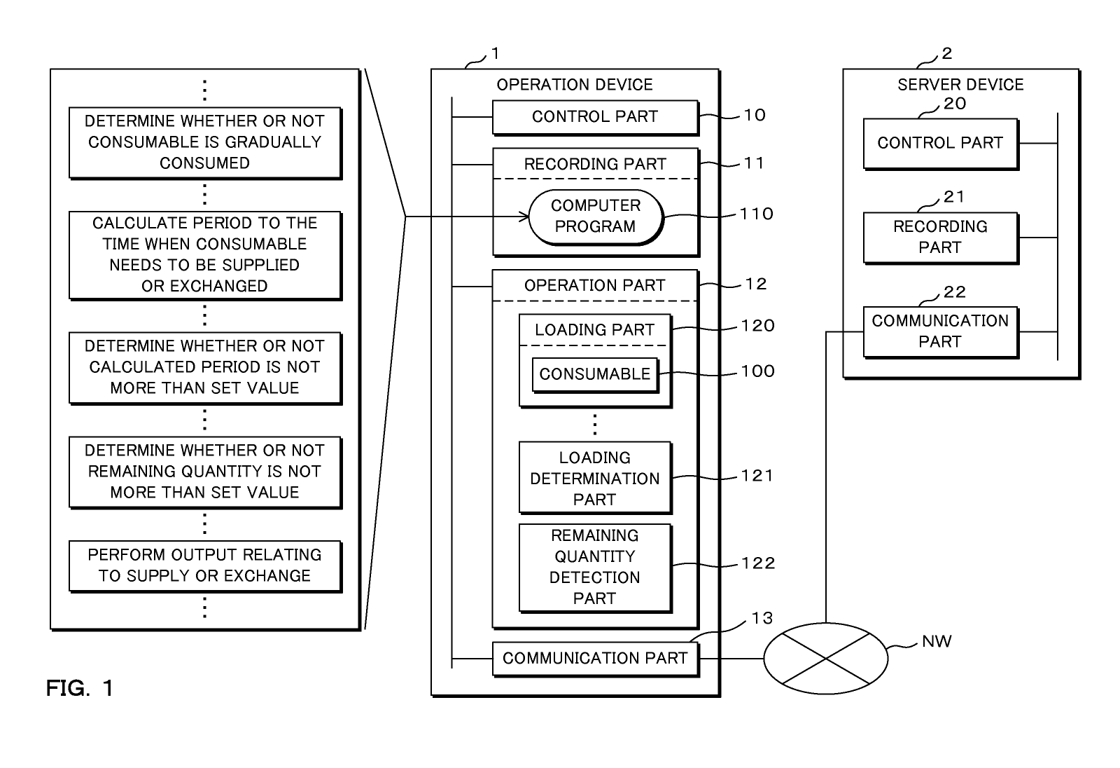

FIG. 1 is a block diagram illustrating a configuration example of an ordering system using an operation device of the present invention. In FIG. 1, the reference numeral 1 denotes an operation device, such as a digital multifunction machine, a copy machine, a facsimile machine. The operation device 1 is connected to a server device 2 via a communication network NW, such as a LAN (Local Area Network).

The operation device 1 operates with gradually consuming a consumable 100 which can be supplied or exchanged, such as a toner, a developer, a photosensitive drum. The operation device 1 includes various parts, such as a control part 10, a recording part 11, an operation part 12, a communication part 13 or the like.

The control part 10 is a part such as a CPU (Central Processing Unit) that controls the device as a whole and executes each processing which is described later. Also, the control part 10 includes various functions, such as a clock function which performs clocking of a period of date and time as well as an instruction for the date and time, which are necessary for each processing.

The recording part 11 represents different types of recording means for recording various information and is a part, namely, a volatile memory, such as various types of RAMs, for temporarily recording information, and a non-volatile memory, such as a ROM, a hard disc drive. The recording part 11 described herein is a general term of one or a plurality of information recording media that are accessible from the control part 10.

In the recording part 11, a computer program 110 is recorded which includes various procedures for causing a computer such as a digital multifunction machine to operate as the operation device 1 of the present invention. It may be possible to incorporate a circuit as a hardware for executing similar procedures into the operation device 1, instead of causing the recording part 11 to record each procedure relating to the computer program 110 as a software.

An operation part 12 is a general term of various parts, such as an image reading part, an image forming part, and an image forming medium processing part, which operate with gradually consuming the consumable 100. Also, the operation part 12 includes various parts regarding the consumable 100, such as a plurality of loading parts 120 respectively loading a plurality of consumables 100, a loading determination part 121 that determines whether the consumable 100 is loaded or not, and a remaining quantity detection part 122 that detects the remaining quantity of the loaded consumable 100.

When it is determined that the consumable 100 is loaded into the loading part 120, the loading determination part 121 notifies the control part 10 of information indicating the loaded consumable 100. Then, the control part 10 records in the recording part 11 the loading timing such as date and time on which the consumable 100 is loaded, in such a manner that a loading timing is associated with the information indicating the consumable 100. Also, the remaining quantity of the consumable 100 detected by the remaining quantity detection part 122 is recorded in the same manner. That is, the control part 10 records in the recording part 11 the remaining quantity of the consumable 100 detected by the remaining quantity detection part 122 in such a manner that the remaining quantity is associated with the information indicating the consumable 100 and the information indicating the detecting timing such as the date and time on which the detection was performed. Accordingly, in the recording part 11, information indicating the loaded consumable 100 and the loading timing are recorded, as well as the information indicating the consumable 100, the remaining quantity and the date and time on which the detection was performed are recorded.

The communication part 13 is a network interface connected to a communication network NW such as a LAN (Local Area Network), and includes a LAN port and various circuits such as an auxiliary circuit thereof.

The server device 2 is a device using a computer for a server, and includes various parts, such as a control part 20, a recording part 21, and a communication part 22.

The control part 20 is a part such as a CPU which controls the device as a whole. The recording part 21 is one or a plurality of information recording media such as a volatile memory and a non-volatile memory, which is recorded various information.

The communication part 22 is an interface part connected to a communication network NW.

As illustrated in FIG. 1, the operation device 1 and the server device 2 can communicate with each other via the communication network NW. The operation device 1 can transmit order information requesting an order of the consumable 100 to the server device 2. Also, the server device 2 has a function of executing the order processing based on the received order information. The function of executing order processing is, for example, a function of requesting a delivery of the consumable 100 to a supplier of the consumable 100. It is realized by transmitting the order information indicating the order contents to a communication device managed by the supplier.

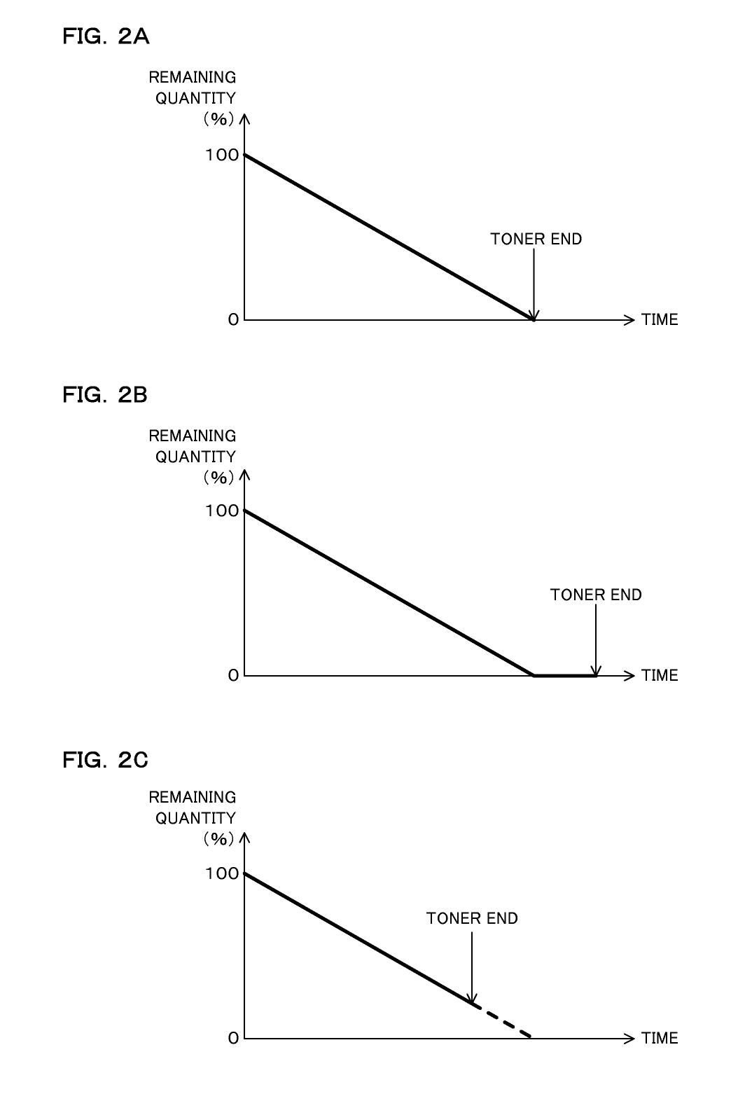

Next, the overview of proper adjustment for an order timing by the operation device 1 of the present invention is described. FIG. 2A, FIG. 2B, and FIG. 2C are graphs each illustrating a premise of processing for properly adjusting an ordering timing according to the operation device 1 of the present invention. FIG. 2A, FIG. 2B, and FIG. 2C show a change with time of the detected value of the remaining quantity of the toner, by expressing a time at the horizontal axis and a remaining quantity of a toner (%) at the vertical axis. For easy understanding, it is assumed that the toner is consumed at a constant speed. The remaining quantities of the toner (%) shown in FIG. 2A, FIG. 2B, and FIG. 2C are values detected by the remaining quantity detection part 122 which detects a value of the remaining quantity of the toner (%) based on a driving period of a toner motor. Also, each of FIG. 2A, FIG. 2B, and FIG. 2C illustrates a difference between the time when the remaining quantity of the toner as detected by the remaining quantity detection part 122 becomes 0% and the actual time when the toner is completely consumed. The actual time when the toner is completely consumed means a time when the toner density detected by a toner density sensor maintains at a low level for a certain period of time, that is, the time when it is determined as a so-called toner end.

FIG. 2A illustrates a case in which the time when the remaining quantity of the toner detected by the remaining quantity detection part 122 becomes 0% matches the toner end. FIG. 2B illustrates a case in which the toner end occurs after the remaining quantity of the toner detected by the remaining quantity detection part 122 becomes 0%. FIG. 2C illustrates a case in which the toner end comes earlier than the remaining quantity of the toner detected by the remaining quantity detection part 122 becomes 0%.

Under the circumstance illustrated by FIG. 2A, there is no problem because no error occurs in detection of the remaining quantity of the toner by the remaining quantity detection part 122. Under the circumstance illustrated by FIG. 2B, the following problem occurs. Since the remaining quantity detection part 122 detects that the toner is consumed greater than the actual status, the timing for ordering a consumable for exchange comes too early, which results in a longer storage period and an increase in the storage amount. Under the circumstance illustrated by FIG. 2C, the following situation may occur. Since the remaining quantity detection part 122 detects that the toner is consumed less than the actual status, the timing of ordering a consumable for exchange is delayed, thereby the toner cannot be delivered by the time when the toner requires exchange, so that the operation device 1 cannot be used.

The operation device 1 according to the present invention is to properly adjust an ordering timing irrespective of the detection errors, and is capable of executing order processing, for example, when the remaining quantity of the toner becomes not more than 25% at the latest. A condition of the determination processing for determining the necessity of executing the order processing is described in detail below.

The necessity of starting an execution of the determination processing is decided by determining whether or not the consumable 100 such as a toner is gradually consumed. Specifically, when the operation part 12 detects that the consumable 100 is consumed by executing processing such as image forming processing or the like, or when the remaining quantity detection part 122 detects a change in the remaining quantity, it is determined that the consumable 100 is gradually consumed. For example, the remaining quantity detection part 122 determines that the consumable 100 is consumed when the detected remaining quantity of the toner is reduced by not less than 1% from the previously detected remaining quantity of the toner.

In the determination processing, the order timing of the consumable 100 is obtained by calculating a period to the time when the exchange of the consumable 100 is required according to a change with time of the detected remaining quantity. For example, a consumption period per 1% of the remaining quantity as a change with time is obtained by dividing a period from the time such as date when the consumable 100 was supplied or exchanged to the present by the consumed quantity of the consumable 100. A period required for exhausting is calculated by multiplying the obtained consumption period by 100. The date when the consumable 100 was supplied or exchanged can be used for the calculation processing, for example, by determining whether or not a toner which is the consumable 100 is loaded into the loading part 120 by the loading determination part 121, and recording the determined timing such as date or date and time in the recording part 11.

As to the above-described calculation of the period required for exhausting, the timing when the consumption of the consumable 100 is completed, for example, a period to the time when the remaining quantity of the toner becomes 0%, is predicted by the formula 1 as shown below. Although the formula 1 illustrates an expression predicting a timing by the number of days, it is possible to appropriately making the setting to further predict, for example, hours and minutes.

Exhausting prediction period=(100×(current date−loading date))/(100−remaining quantity (%)) Formula 1

The exhausting prediction period calculated by formula 1 represents a period from the loading date to the time when the remaining quantity of the toner becomes 0%. When a value indicating a prediction period, which is obtained by subtracting the value of elapsed days from the loading date from the value of the calculated exhausting prediction period, is not more than the set value, the order processing is executed. The set value is a value set in advance which indicates a period, such as 30 days. That is, when it is less than 30 days until the remaining quantity of the toner becomes 0%, it is assumed to be less than one month from the predicted date when the remaining quantity of the toner becomes 0%, and then an order is placed.

Also, even if the value indicating the prediction period is not more than the set value, when the current date and the loading date are the same, the order processing is not executed. However, when the remaining quantity of the toner is not more than a set value, such as 50%, it is assumed that the toner is rapidly being consumed and the order processing is executed.

Also, when the remaining quantity of the toner is not more than the set value, such as 25%, the order processing is executed irrespective of the prediction period. This is to avoid a situation that the speed of toner consumption becomes faster later on and a delivery of a toner cannot be made in time, whereby the operation device 1 cannot be used. That is, this is to avoid a situation that the operation device 1 cannot be used due to a variation in the amount used.

Moreover, the prediction period is calculated only when the remaining quantity of the toner is not more than the set value, such as 50%. That is, this is to reduce the processing load by determining that an order placement is unnecessary when the remaining quantity of the toner is over 50%.

By making the above-described setting, the order processing is executed basically when the remaining quantity of the toner ranges from 25 to 50%. When the order processing for the consumable 100 has already been executed, the order processing for the consumable 100 is restricted so as not to be executed. This is to avoid duplication of the order processing.

Also, when there are a plurality of consumables 100 which need to be supplied or exchanged, for example, when multiple colors of toners are used, or when a consumable 100 other than a toner, which is a developer, a photosensitive drum or the like is used, the operation device 1 adjusts a set value so as to place the order processing for the consumables 100 at the same time.

In the determination processing, the operation device 1 does not always determine the necessity of the order processing based on the calculated prediction period, but executes the processing only when it is necessary based on a setting by an user. That is, the operation device 1 has various types of modes such as a fixed value order mode for determining the necessity of the order processing only based on the remaining quantity detected by the remaining quantity detection part 122, a consumption prediction mode which is based on the calculated prediction period. Then, the contents of the determination processing are appropriately changed according to the mode as set.

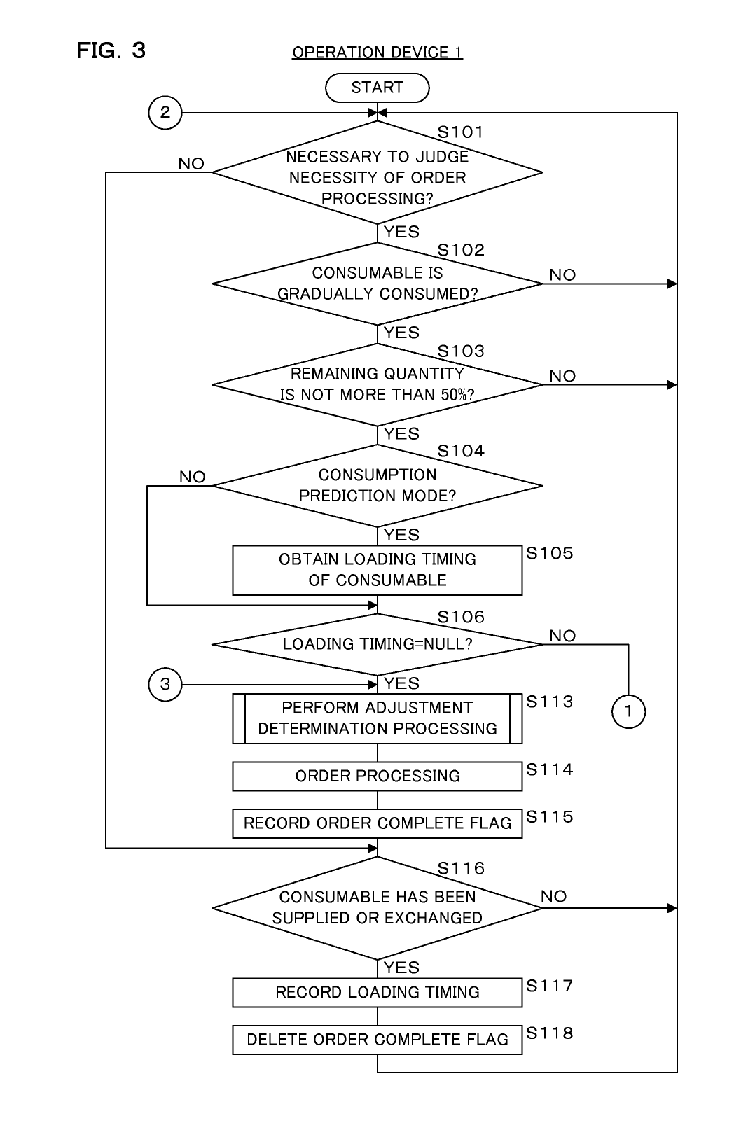

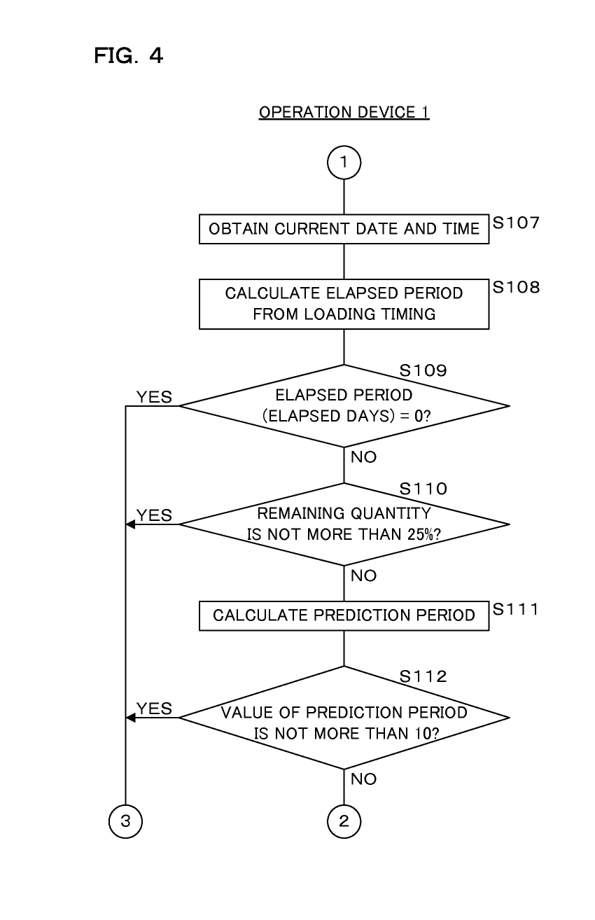

One example of the determination processing which is executed under the above-mentioned conditions are concretely described by using a flowchart. FIGS. 3 and 4 illustrate a flowchart showing one example of the determination processing in the operation device 1 of the present invention. The operation device 1 executes the following determination processing by control of the control part 10 which executes various procedures indicated by the computer program 110.

The control part 10 determines the status of supply or exchange of the consumable 100, and determines when it is necessary to judge the necessity of the order processing (step S101). The status of supply or exchange of the consumable 100 which is determined at step S101 corresponds to processing for determining whether or not the order processing for the consumable 100 has already been executed. More specifically, when the order processing is executed, it is determined whether or not an order complete flag indicating that the order processing for the consumable 100 has been executed is recorded (set) in the recording part 11. In a case where the order complete flag is recorded in the recording part 11, it is determined that the order processing for the consumable 100 has already been executed. Also, in a case where the order complete flag is not recorded in the recording part 11, it is determined that it is necessary to judge the necessity of the order processing for the consumable 100 which has been supplied or exchanged. When the consumable 100 is supplied or exchanged after placing the order, the order complete flag is deleted (reset), whereby it can be determined that the currently loaded consumable 100 is the one that has been supplied or exchanged after placing the order.

At step S101, when the consumable 100 has been supplied or exchanged after order processing is executed, and it is determined that judgment on the necessity of the order processing is necessary (step S101: YES), the control part 10 determines whether or not the consumable 100 is gradually consumed (step S102). The determination method of step S102 is described as above. For example, it is determined based on a change in the remaining quantity detected by the remaining quantity detection part 122. Processing for the following case is described later. That is, in a case where, at step S101, after executing the order processing, the consumable has not been supplied or exchanged, and it is determined that judgment on the necessity of the order processing is not necessary.

At step S102, when it is determined that the consumable 100 is not gradually consumed (step S102: NO), the control part 10 returns the processing to step S101, and repeats the subsequent processing.

At step S102, when it is determined that the consumable 100 is gradually consumed (step S102: YES), the control part 10 determines whether or not the remaining quantity detected by the remaining quantity detection part 122 is not more than a set value set in advance, which is not more than 50% herein (step S103).

At step S103, when it is determined that the remaining quantity of the toner is more than 50% (step S103: NO), the control part 10 returns the processing to step S101, and repeats the subsequent processing. That is, when the remaining quantity of the toner is more than 50%, it is determined that placing an order is not necessary.

At step S103, when it is determined that the remaining quantity is not more than 50% which is the set value (step S103: YES), the control part 10 determines whether it is in the consumption prediction mode or not (step S104). As described above, the operation device 1 determines the necessity of placing an order based on calculating a prediction period when it is in the consumption prediction mode, and determines the necessity of placing an order only based on the remaining quantity when it is in the fixed value order mode. As the remaining quantity is determined as 50% at step S103, when it is in the fixed value order mode, the processing relating to an order preparation, which is described later, is executed.

At step S104, when it is determined as the consumption prediction mode (step S104: YES), the control part 10 obtains information indicating a loading timing of the consumable 100 recorded in the recording part 11 (step S105). However, information indicating a loading timing of the consumable 100 is not necessarily recorded in the recording part 11. When information indicating the loading timing is not recorded, a variable “NULL” is obtained. Such a setting is performed in a case where information indicating the loading timing is not recorded, for example, where the consumption prediction mode is not applied to a certain consumable 100 among a plurality of the consumables 100.

The control part 10 determines whether the obtained information indicating the loading timing is “NULL” or not (step S106).

At step S106, when it is determined that the information is not “NULL” (step S106: NO), the control part 10 obtains information indicating a current date and time (step S107). Obtaining the information indicating the current date and time is performed by, for example, reading out the information indicating date and time from the clocking function preliminary included in the control part 10.

Then, the control part 10 calculates an elapsed period from the loading timing based on the information indicating the loading timing obtained at step S105 and the information indicating the current date and time obtained at step S107 (step S108). The elapsed period at step S108 means the period from the loading timing to the current date and time. Here, an example is described that the elapsed period is calculated by the number of days and used for the subsequent processing.

The control part 10 determines whether the calculated elapsed period (the elapsed days) is 0 or not (step S109). When the elapsed period is 0, that is, when it is possible that the toner is being consumed rapidly because the remaining quantity of the toner becomes not more than 50% on the loading day, processing relating to an order preparation is executed, which is described later. Here, it is determined whether the elapsed period is 0 or not since the elapsed days is used as the elapsed period. In a case where, for example, a time indicated by hours and minutes is used as the elapsed period, it is determined whether the elapsed period falls within a predetermined elapsed time or not.

At step S109, when it is determined that the elapsed period is not 0 (step S109: NO), the control part 10 determines whether or not the remaining quantity detected by the remaining quantity detection part 122 is not more than a set value which is set in advance, not more than 25% herein (step S110). When the remaining quantity of the toner is not more than 25%, the processing relating to an order preparation, which is described later, is executed irrespective of the consumption status.

At step S110, when it is determined that the remaining quantity is more than 25% (step S110: NO), the control part 10 calculates a prediction period (step S111). The prediction period at step S111 is the period from the present to the time when the remaining quantity of the toner becomes 0, and is calculated by using the formula 1 as described above. Herein, the prediction period is calculated as a value for indicating the number of days.

The control part 10 determines whether or not the calculated value indicating the prediction period is not more than a set value which is set in advance, not more than 10 herein (step S112). Here, since the prediction period is calculated as a value for indicating the number of days, the processing at step S112 is the processing for determining whether or not the period to the time when the remaining quantity becomes 0% is within 10 days. Then, in a case where the period to the time when the remaining quantity becomes 0% is within 10 days, the processing relating to an order preparation, which is described later, is executed.

At step S112, when it is determined that the value indicating the prediction period is more than 10 (step S112: NO), the control part 10 returns the processing to step S101, and repeats the subsequent processing.

When it is determined at step S106 that the information indicating the loading timing is “NULL” (step S106: YES), when it is determined at step S109 that the calculated elapsed period is 0 (step S109: YES), when it is determined at step S110 that the remaining quantity of the toner is not more than 25% (step S110: YES), and when it is determined at step S112 that the value indicating the prediction period is not more than 10 (step S112: YES), the control part 10 executes processing relating an order preparation.

As processing relating an order preparation, the control part 10 performs an adjustment determination processing for determining whether or not the order processing is necessary for a different consumable 100 after adjusting various set values (step S113). At step S113, the adjustment determination processing for determining the necessity of the order processing is performed based on a standard that is different from usual so that the order processing for the different consumable 100 required to be supplied or exchanged can be performed at the same time.

Then, the control part 10 executes the order processing for transmitting order information for ordering the consumable 100 to the server device 2 from the communication part 13 via the communication network NW (step S114), and records (sets) the order complete flag in the recording part 11 (step S115). At step S114, as the processing relating to supply or exchange of the consumable 100, the order information is transmitted to the server device 2. At the server device 2, as the order processing based on the order information, a request for a delivery of the consumable 100 is made to a supplier of the consumable 100. It is also possible to transmit the order information directly to the supplier, instead of transmitting the order information to the server device 2. Moreover, it is also possible to perform the order processing by outputting the order to a person in charge of ordering, for example, in a method of email-transmitting, outputting on a paper medium or the like.

Then, the control part 10 determines whether or not the consumable 100 to be ordered has been supplied or exchanged (step S116). As for the determination at step S116, the consumable 100 is determined as supplied or exchanged when, for example, it is detected that the consumable 100 is loaded in the loading part 120 after the order processing is performed.

At step S116, when it is determined that the consumable 100 has not been supplied or exchanged (step S116: NO), the control part 10 returns the processing to step S101, and repeats the subsequent processing.

At step S116, when it is determined that the consumable 100 has been supplied or exchanged (step S116: YES), the control part 10 records in the recording part 11 a loading timing such as date and time when the consumable 100 is loaded, in such a manner that the loading timing is associated with information indicating the consumable 100 (step S117).

Then, the control part 10 deletes (resets) the order complete flag from the recording part 11 (step S118), returns the processing to step S101, and repeats the subsequent processing.

At step S101, when the consumable 100 has not been supplied or exchanged after performing the order processing, and it is determined that judgment on the necessity of the order processing is not necessary (step S101: NO), the control part 10 proceeds the processing to step S116, and repeats the subsequent processing. When the consumable 100 has not been supplied or exchanged, double ordering can be prevented by not making judgment on the necessity of the order processing.

In this manner, the determination processing for the consumable 100 is executed.

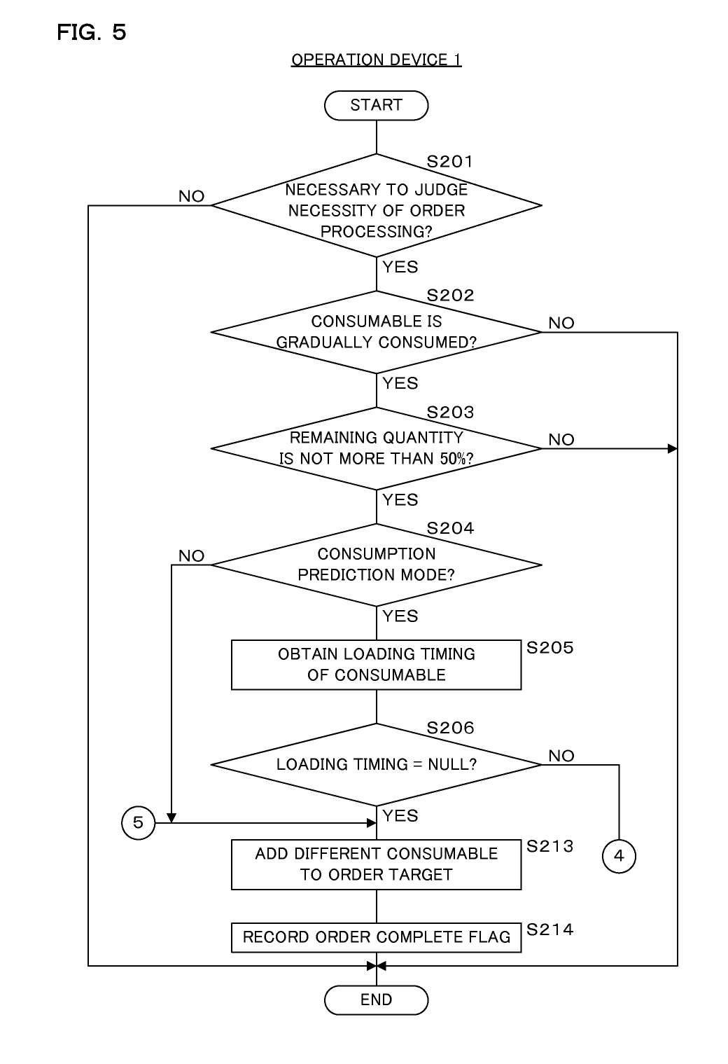

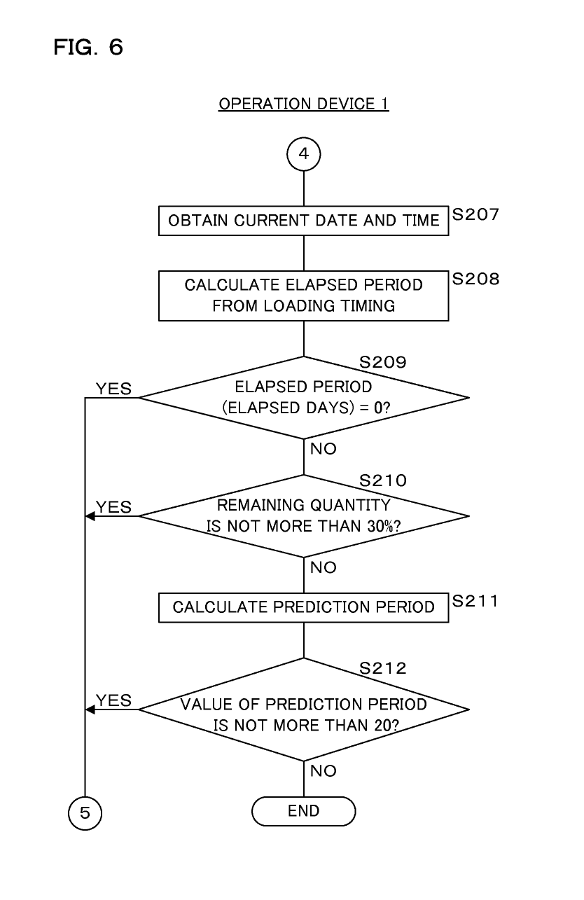

Next, the adjustment determination processing is described, which is started at step S113 at the determination processing described by using FIGS. 3 and 4. FIGS. 5 and 6 show a flowchart illustrating one example of the adjustment determination processing at the operation device 1 of the present invention. The adjustment determination processing determines, when performing order processing for one consumable 100 among a plurality of consumables 100, whether or not it is possible to place an order for a different consumable 100 at the same time. The determination as to whether placing an order at the same time is possible or not is performed by adjusting various set values and easing conditions. Accordingly, the adjustment determination processing is similar to the determination processing though a set value is different. The operation device 1 executes the adjustment determination processing as shown below, by control of the control part 10 that executes various procedures shown in the computer program 110.

The control part 10 determines the status of supply or exchange of the different consumable 100 and determines when it is necessary to judge the necessity of the order processing (step S201). The status of supply or exchange of the different consumable 100 which is determined at step S201 is processing for determining whether or not the order processing for the different consumable 100 has already been executed. More specifically, when the order processing is executed, it is determined whether or not an order complete flag indicating that the order processing for the different consumable 100 is executed is recorded (set) in the recording part 11.

At step 201, when the different consumable 100 has not been supplied or exchanged after the order processing is performed, and it is determined that judgment on the necessity of order processing is not necessary (step S201: NO), the control part 10 ends the adjustment determination processing.

At step S201, when the consumable 100 has been supplied or exchanged after the order processing is performed, and it is determined that judgment on the necessity of the order processing is necessary (step S201: YES), the control part 10 determines whether or not the different consumable 100 is gradually consumed (step S202).

At step S202, when it is determined that the different consumable 100 is not gradually consumed (step S202: NO), the control part 10 determines placing an order is unnecessary and ends the adjustment determination processing.

At step S202, when it is determined that the different consumable 100 is gradually consumed (step S202: YES), the control part 10 determines whether or not the remaining quantity detected by the remaining quantity detection part 122 is not more than the set value which is set in advance, which is not more than 50% herein (step S203).

At step S203, when it is determined that the remaining quantity is more than 50% which is the set value (step S203: NO), the control part 10 determines that placing an order is unnecessary and ends the adjustment determination processing.

At step S203, when it is determined that the remaining quantity is not more than 50% which is the set value (step S203: YES), the control part 10 determines when it is in the consumption prediction mode or not (step S204).

At step S204, when it is determined as the consumption prediction mode (step S204: YES), the control part 10 obtains information indicating a loading timing of the different consumable 100 recorded in the recording part 11 (step S205).

The control part 10 determines whether or not the obtained information indicating the loading timing is “NULL” (step S206).

At step S206, when it is determined as not to be “NULL” (step S206: NO), the control part 10 obtains information indicating the current date and time (step S207).

Then, the control part 10 calculates the elapsed period from the loading timing of the different consumable 100 based on the information indicating the loading timing obtained at step S205 and the information indicating the current date and time obtained at step S207 (step S208).

The control part 10 determines whether or not the calculated elapsed period (the elapsed days) is 0 (step S209).

At step S209, when it is determined that the elapsed period is not 0 (step S209: NO), the control part 10 determines whether the remaining quantity detected by the remaining quantity detection part 122 is not more than an adjusted set value, which is not more than 30% herein (step S210). When the remaining quantity of the toner is not more than 30%, the processing relating to the order preparation is executed irrespective of the consumption status. At the adjustment determination processing performed for the one consumable 100, an example in which 25% is a set value is shown. At the adjustment determination processing, however, the value is adjusted so as to ease conditions and thus set to 30%.

At step S210, when it is determined that the remaining quantity is more than 30% (step S210: NO), the control part 10 calculates the prediction period (step S211).

The control part 10 determines whether or not the value indicating the calculated prediction period is an adjusted set value, which is not more than 20 herein (step S212). At the determination processing performed for the one consumable 100, an example in which 10 is a set value is shown. At the adjustment determination processing, the value is adjusted so as to ease conditions and thus set to be 20.

At step S212, when it is determined that the value indicating the prediction period is more than 20 (step S212: NO), the control part 10 determines that placing an order is unnecessary and ends the adjustment determination processing.

When it is determined at step S206 that the information indicating the loading timing is “NULL” (step S206: YES), when it is determined at step S209 that the calculated elapsed period is 0 (step S209: YES), when it is determined at step S210 that the remaining quantity of the toner is not more than 30% (step S210: YES), and when it is determined at step S212 that the value indicating the prediction period is not more than 20 (step S212: YES), the control part 10 executes the processing relating to the order preparation.

As for the processing relating to the order preparation, the control part 10 adds the different consumable 100 to the order target (step S213), and records (sets) an order complete flag for the different consumable 100 in the recording part 11 (step S214). By adding the different consumable 100 to the order target at step S213, the order processing at step S114 described with reference to FIGS. 3 and 4 is performed in such a manner that the one consumable 100 and the different consumable 100 are ordered together.

As described above, the adjustment determination processing for the different consumable 100 is performed. In a case where the number of the types of the consumables 100 is three or more, the adjustment determination processing is performed for all the other consumables 100.

As the determination processing is performed per each consumable 100, the following situation occurs. That is, one consumable 100 is ordered one day and another consumable 100 is ordered the following day. Such a situation may cause an increase in logistic cost. Executing the adjustment determination processing makes it possible to place orders together. This avoids the occurrence of the above-described situation, thereby realizing rationalization in logistics and suppressing the logistic cost.

It should be understood that the embodiment described above merely illustrates a part of numerous forms of the present invention. The configuration elements, such as each system, device, mechanism, processing, setting of a condition, are appropriately designed in accordance with purposes, use or the like.

For example, it may be possible to apply the present invention to an operation device which is operated with gradually consuming a consumable that is to be exchanged, such as a cartridge type toner. It may also be possible to apply the present invention to an operation device which is operated with gradually using a consumable that is to be supplied, such as an image forming sheet. Moreover, the operation device is not limited to an image forming device such as a digital multifunction machine, a copy machine, a facsimile machine, and can be applied to various types of devices that consume fuel, such as a driving device.

It is to be noted that the disclosed embodiment is illustrative and not restrictive in all aspects. The scope of the present invention is defined by the appended claims rather than by the description preceding them, and all changes that fall within metes and bounds of the claims or equivalence of such metes and bouds thereof are therefore intended to be embraced by the claims.

1-8. (canceled)

9. An operation device operating with consuming a consumable which can be supplied or exchanged, comprising:
a remaining quantity detection part that detects a remaining quantity of the consumable;
a consuming determination part that determines whether or not the consumable is consumed;
a calculation part that calculates a period to the time when the consumable needs to be supplied or exchanged, based on a change with time of the remaining quantity detected by the remaining quantity detection part, when the consuming determination part determines that the consumable is consumed;
a period determination part that determines whether or not a value indicating the period calculated by the calculation part is not more than a set value; and
an output part that performs an output relating to supply or exchange of the consumable when the period determination part determines that the value is not more than the set value.

10. The operation device according to claim 9, further comprising
a remaining quantity determination part that determines whether or not the remaining quantity detected by the remaining quantity detection part is not more than a set value,
wherein the calculation part calculates the period when the remaining quantity determination part determines that the remaining quantity is not more than the set value.

11. The operation device according to claim 9, further comprising
a status determination part that determines a status of supply or exchange of the consumable after the output part performs the output,
wherein the consuming determination part determines whether or not the consumable is consumed, when the status determination part determines that the consumable has been supplied or exchanged.

12. The operation device according to claim 9, wherein
a plurality of consumables are to be consumed, and
the period determination part performs, based on a set value defined in accordance with a status of supply or exchange of one consumable, a determination relating to another consumable.

13. The operation device according to claim 9, wherein
the output part externally transmits order information for ordering the consumable as an output relating to supply or exchange of the consumable.

14. An operation device operating with consuming a consumable which can be supplied or exchanged, comprising:
a remaining quantity detection part that detects a remaining quantity of the consumable;
a consuming determination part that determines whether or not the consumable is consumed;
a remaining quantity determination part that determines whether or not the remaining quantity detected by the remaining quantity detection part is not more than a set value when the consuming determination part determines that the consumable is consumed; and
an output part that performs an output relating to supply or exchange of the consumable when the remaining quantity determination part determines that the remaining quantity is not more than the set value.

15. The operation device according to claim 14, further comprising
a status determination part that determines a status of supply or exchange of the consumable after the output part performs the output,
wherein the consuming determination part determines whether or not the consumable is consumed, when the status determination part determines that the consumable has been supplied or exchanged.

16. The operation device according to claim 14, wherein
a plurality of consumables are to be consumed, and
the remaining quantity determination part performs, based on a set value defined in accordance with a status of supply or exchange of one consumable, a determination relating to another consumable.

17. The operation device according to claim 14, wherein
the output part externally transmits order information for ordering the consumable as an output relating to supply or exchange of the consumable.

18. A non-transitory computer-readable recording medium in which recorded is a computer program for causing a computer, which operates with consuming a consumable which can be supplied or exchanged, to perform procedures of:
determining whether or not the consumable is consumed;
calculating a period to the time when the consumable needs to be supplied or exchanged, based on a change with time of a remaining quantity of the consumable, when it is determined that the consumable is consumed;
determining whether or not a value indicating the calculated period is not more than a set value; and
performing an output relating to supply or exchange of the consumable when it is determined that the value is not more than the set value.

19. A non-transitory computer-readable recording medium in which recorded is a computer program for causing a computer, which operates with consuming a consumable which can be supplied or exchanged, to perform procedures of:
determining whether or not the consumable is consumed;
determining whether or not a remaining quantity of the consumable is not more than a set value when it is determined that the consumable is consumed; and
performing an output relating to supply or exchange of the consumable when it is determined that the remaining quantity is not more than the set value.
